(19) United States
(12) Patent Application Publication
(10) Pub. No.: US 2007/0167060 A1
(43) Pub. Date: Jul. 19, 2007

(54) Card dispenser

(75) Inventor: Raymond W. Coles, Dorset (GB)

Correspondence Address: MARSHALL, GERSTEIN & BORUN LLP, 233 S. WACKER DRIVE, SUITE 6300, SEARS TOWER, CHICAGO, IL, 60606, US

(73) Assignee: ULTRA ELECTRONICS LIMITED, Middlesex (GB)

(21) Appl. No.: 10/571,308

(22) PCT Filed: Sep. 10, 2004
(86) PCT No.: PCT/GB04/03881

§ 371 Date: Jan. 3, 2007

(30) Foreign Application Priority Data
Sep. 12, 2003 (GB) 0321461.6

(51) Int. Cl. H01R 13/62

(52) U.S. Cl. 439/326

(57) ABSTRACT

There is provided apparatus for dispensing a card or other substantially planar substrate therefrom, the apparatus comprising a base (2) in engagement with a cover (3), the cover being arranged to house a plurality of cards (6) therein, the cover and base being arranged to be movable with respect to one another such that on relative motion of the base and cover one of the plurality of cards is removable from the apparatus, wherein the cover includes an outwardly protruding ledge (19) such that, when the apparatus is in a configuration allowing removal of a card, the ledge is configured and/or dimensioned to prohibit the grasping of the top surface of the card by a user.

The present application relates primarily to a card dispenser, and particularly but not exclusively, to a card dispenser for dispensing blank security cards prior to a printing operation to create the security cards.

It is known in the art to produce security cards by performing a printing process on a blank plastic substrate, or card blank. The card blank is generally of similar size to a standard credit card and the printing process is generally a thermal dye transfer printing process. These security cards produced often include a picture of the intended bearer of the card, together with appropriate information, such as the bearer's name and the name of the company or facility issuing the security card, as well as one or more security features such as embedded logos. An example of a pre-patterned security blank and a printer suitable for generating a security card from the card blank are described respectively in UK application numbers GB 0130377.5 and GB 0305471.5.

As mentioned above, the printing process most commonly used is a thermal transfer printing process in which one or more carrier films that carry a layer of ink are brought into contact with a card blank and a thermal printing head heats the ink layer in the positions in which printing is to occur, thus transferring the ink to the card blank. A disadvantage with using such a printing system is that any imperfections or deposits on the card blank, such as dust, scratches or fingerprints, occlude the ink layer as it is deposited onto the card, therefore causing an imperfection in the finished security card.

A solution to this problem is to provide a card storage and feeding mechanism as part of the card printer. This allows a number of card blanks to be stored within the mechanism and introduced to the printer directly from the storage area. However, the required card feeding mechanisms tend to be relatively complex and prone to malfunction, mainly due to roller polishing, where the surface of the feed rollers become polished smooth through use and therefore do not grip the cards properly, and static attraction between individual cards in a stack that prevents individual cards being fed properly. Not only does this increase the cost of manufacture of the printer but it may also cause a relatively high number of faults in the card feeding mechanism that the printer manufacturer is obliged to rectify under the terms of the warranty.

According to a first aspect of the present invention there is provided apparatus for dispensing a card or other substantially planar substrate therefrom, the apparatus comprising a base in engagement with a cover, the cover being arranged to a house a plurality of cards therein, the cover and base being arranged to be movable with respect to one another such that on relative motion of the base and cover one of the plurality of cards is removable from the apparatus, wherein the cover includes an outwardly protruding ledge such that, when the apparatus is in a configuration allowing removal of a card, the ledge is configured and/or dimensioned to prohibit the grasping of the top surface of the card by a user.

The cover is preferably arranged to house the plurality of cards in a stack, with the lowermost card of the stack being removable from the apparatus on relative motion of the base and cover.

Additionally, the relative motion of the cover with respect to the base imparts a relative motion of the plurality of cards with respect to the base with the exception of the card to be made accessible from the apparatus.

The relative motion between the cover and base is preferably a linear motion.

The base may additionally have at least one wall portion that is arranged to be in engagement with a side surface of the lowermost card, wherein the wall portion maintains the lowermost card substantially stationary with respect to the base during the relative motion of the cover and base.

The relative motion between the base and cover is preferably a reciprocating motion and the wall portion of the base may be arranged to limit relative motion between the base and the lowermost card in one direction only. In a preferred embodiment, when the apparatus is in use, it is only possible for the user to grasp the card by the edges, i.e. the user is constrained to handle the card by the edges only. The ledge may preferably be narrower in width than the width of a card.

Additionally the apparatus may include card gripping means arranged to grip the lowermost card and impart relative motion between the card and the base in the return direction. The card gripping means may be friction pads mounted to the cover.

The cover may be urged back towards an initial rest position by a suitable resilient member, preferably a spring. Alternatively or additionally, the motion of the cover may be controlled by a motor.

The base may additionally have at least one wall portion that is arranged to be in engagement with a side surface of the lowermost card, wherein the wall portion maintains the lowermost card substantially stationary with respect to the base during the relative motion of the cover and base. The wall portion of the base may be arranged to limit relative motion between the base and the lowermost card in one direction only.

Additionally or alternatively, the cover and base are fastened to one another by means of at least one retaining element, the retaining element being arranged to fracture on removal from the apparatus. The or each retaining element may comprise an elongate side element and at least one retaining limb depending from the side element at substantially 90°. At least one slot may be formed in the body of the cover and at least one aperture may be formed in the base such that a retaining limb may be inserted through each at least one slot and aperture, such that the base and the cover are fastened together.

The at least one retaining limb may be arranged to be latched in engagement with the base and may have at least one weakened area, the weakened area being arranged to fracture on application of a force in excess of a predetermined amount.

Additionally or alternatively, the retaining limb may comprise a guide element over which a portion of the cover can move.

Additionally or alternatively, the apparatus may comprise a resilient member arranged to urge the plurality of cards towards the base. The resilient member may preferably be located between the cover and may be arranged to exert a force against the cover and the plurality of cards. The resilient member may comprise a cover engaging portion. The cover may comprise protrusions formed on the inside of the cover wherein apertures are formed in the cover engaging portion of the resilient member, the protrusions and apertures being positioned such that, when the apparatus is assembled, each protrusion engages with an aperture. The cover engaging portion of the resilient member may be shaped so as to fit closely around the interior of the cover. The resilient member may further comprise at least one spring portion which may depend from the rearmost segment of the cover engaging portion. The at least one spring portion may be formed as an elongate strip.

According to a second aspect of the present invention there is provided a card dispenser for dispensing a card from a stack of cards housed within the dispenser, the card dispenser comprising a base and a cover in engagement with one another and arranged to undergo a reciprocating motion with respect to one another, the base comprising a card restraining element in engagement with the bottom card of the stack and the cover being arranged to move the remainder of the stack with respect to the base during the reciprocating motion, wherein the bottom card is made accessible for removal from the dispenser.

An embodiment of the present invention is described below, by way of illustrative example only, with reference to the accompanying figures, of which:

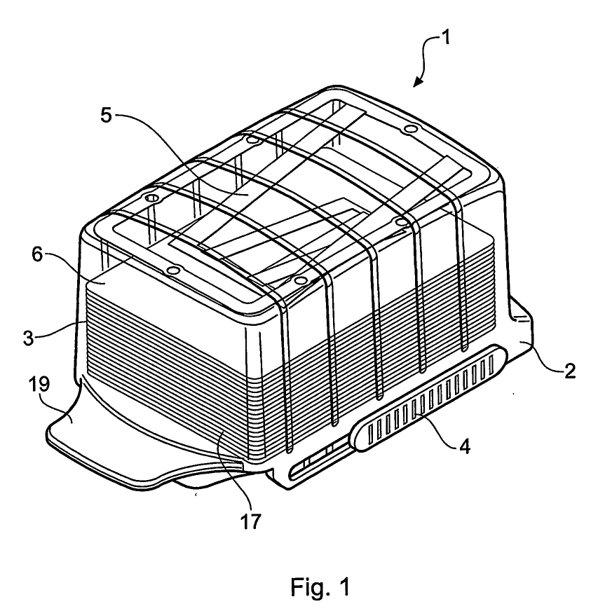

FIG. 1 is a perspective view of a card dispenser according to an embodiment of the present invention;

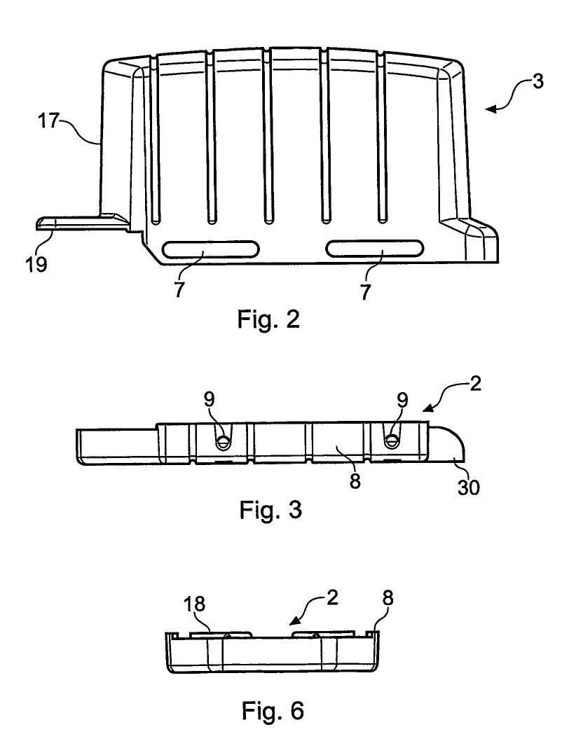

FIG. 2 is a side view of the cover of the card dispenser shown in FIG. 1;

FIG. 3 is a side view of the base of the dispenser shown in FIG. 1;

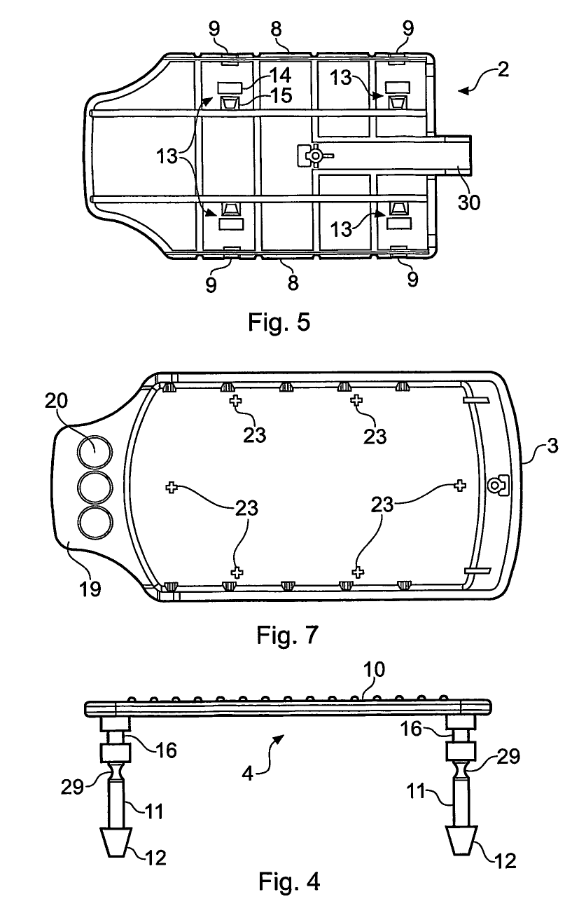

FIG. 4 is a plan view of the elongate side member shown in FIG. 1;

FIG. 5 is a plan view of the base shown in FIG. 3;

FIG. 6 is a front view of the base shown in FIG. 3;

FIG. 7 is a view of the interior of the cover shown in FIG. 2;

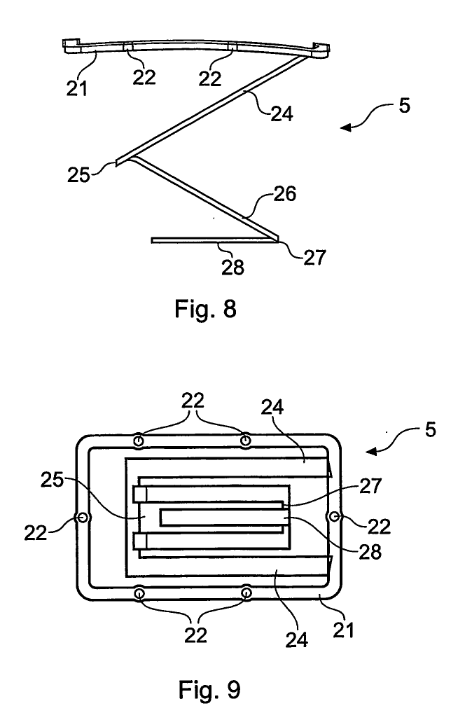

FIG. 8 is a side view of a spring unit included within the dispenser of FIG. 1; and

FIG. 9 is a plan view of the spring unit shown in FIG. 4.

FIG. 1 illustrates a perspective view of a card dispenser 1 according to an embodiment of the present invention. The dispenser 1 comprises a base 2, a cover 3, or shell, the base and cover being fastened together by means of a retainer 4 at either side of the dispenser. A spring element 5 is also provided to exert a downward pressure on the stack of card blanks 6 provided within the dispenser 1. The relationship between the various parts of the dispenser 1 and its operation are described in more detail with reference to the following figures.

The cover 3 of the dispenser 1 is shown in side view in FIG. 2. Two horizontal slots 7 are formed along the bottom edge of either side of the cover 3. A side view of the base is shown in FIG. 3. In each of the two opposing side walls 8 of the base two apertures 9 are formed that, when the base 2 and cover 3 are fastened together and are in the rest position, are in alignment with the rear portions of the slots 7 in the cover 3. The base 2 and the cover 3 are fastened together by means of the retainers 4, one of which is shown in plan view in FIG. 4. Each retainer 4 comprises an elongate side element 10, at either end of which a retaining limb 11 depends at substantially 90°. The free ends of the retaining limbs 11 have frusto-conical sections 12 formed thereon. In the assembled state, the retaining limbs 11 of the retainers 4 are passed through the slots 7 in the cover 3 of the dispenser 1, through the aligned apertures 9 in the side walls 8 of the base 2 and are brought into engagement with retaining catches 13 formed in the base 2 of the dispenser. The retaining catches 13 are illustrated in FIG. 5, which shows a plan view of the base 2 of the dispenser. Each retaining catch 13 comprises a latch element 14 and a seating element 15. As the retaining limbs 11 of the retainer 4 are inserted through the side walls of the base 2, the lower sections of the frusto-conical segments 12 come into contact with the upper surface of the latch elements 14. Continued motion of the retaining limbs 11 causes the frusto-conical segments 12 to ride up over the latch elements 14 and to come to rest within the seating elements 15, which are correspondingly shaped to receive the frusto-conical segments. The lip created by the junction between the frusto-conical segment 12 and the narrowed portion of the retaining limb is in engagement with an edge of the latch element 14, thereby preventing the retainer 4 from being withdrawn from the base 2.

In operation, to dispense a card the cover 3 of the dispenser is drawn back, thus causing the cover 3 to move relative to the base 2. The extent of travel over which the cover 3 can move relative to the base 2 is defined by the length of the horizontal slots 7 in the cover 3. The relative motion of the cover and the base is facilitated due to the fact that the bottom edge of the sides of the cover 3 are resting on a narrowed portion 16 of each of the retaining limbs of the retainers 4, as illustrated in FIG. 4. The narrowed portion 16 of the retaining limbs 11 therefore guide the edges of the cover 3 as it is drawn back. As the retainers 4 are secured to the base 2, they remain stationary. As the cover 3 is drawn back, the inside of the front walls 17 of the cover forces the majority of the stack of card blanks 6 to also travel back in unison with the cover 3. However, the lowermost card of the stack 6 remains stationary with the base 2. This is because the side walls 8 of the base, together with a pair of rear wall portions 18, as shown in FIG. 6, are raised slightly above the surface of the base on which the stacks of cards 6 rests. The side and rear wall portions extend above the surface of the base on which the stack of cards rests by an amount that is slightly less than the thickness of a single one of the cards within the stack 6. Consequently, the rear wall portions 18 of the base 2 prevent the lowermost card of the stack of cards 6 from moving backwards with the cover 3 and the rest of the stack of cards 6.

At the full extent of the rearwards travel of the cover 3, the front edge of the lowermost card is substantially aligned with the front edge of the horizontal ledge 19 formed at the bottom of the front wall 17 of the cover 3. As the horizontal ledge 19 is arranged to be narrower in width than the width of a card, the user is obliged to grasp the edges of the lowermost card in order to withdraw it from the dispenser 1. The ledge effectively prohibits the upper surface of the card from being grasped by the user, thus preventing the contamination of the surface with finger prints.

Alternatively, in some embodiments of the present invention, one or more card gripping portions 20 may be provided on the underside of the horizontal ledge 19. When the cover 3 is drawn back, the card gripping portions, which, for example, may be rubber disks, are brought into contact with the upper surface of the lowermost card of the stack 6. As the cover 3 is then brought forwards again, the friction between the card gripping portions 20 and the top surface of the lower most card causes the lowermost card to be drawn forward together with the cover 3, such that when the cover 3 returns to its initial resting position, the lowermost card can be easily grasped and fully withdrawn from the dispenser 1. As the horizontal ledge 19 is arranged to be narrower in width than the width of a card, the user is obliged to grasp the edges of the lowermost card in order to withdraw it from the dispenser. The ledge effectively prohibits the upper surface of the card from being grasped by the user, thus preventing the contamination of the surface with finger prints. The card gripping portions 20 are illustrated in FIG. 7, which shows an underside view of the cover 3 of the dispenser.

The cover 3 of the dispenser may, in some embodiments of the present invention, be urged back towards its initial rest position by the action of a suitable resilient member, such as a spring. For example, a tension spring may be secured to the base 2 and cover 3 such that the spring is extended when the cover 3 is drawn back to dispense a card. The restoring force of the spring is ideally sufficient to return the cover 3 to its initial position. In further embodiments of the present invention the motion of the cover 3 may be caused by a motor, such as a battery operated electric motor.

When the dispenser has been brought back to the initial resting position, the lowermost card, which was previously the second lowermost card, drops into the recess defined by the upper edges of the side walls 8 and the rear wall portions 18. In a preferred embodiment of the present invention, a spring element 5 is provided to urge the stack of cards 6 towards the base 2. The spring element 5 is illustrated in FIGS. 8 and 9. FIG. 5 shows a side view of the spring element 5 in a partially compressed state. The spring element 5 comprises an uppermost cover engaging portion 21 that is a substantially rectangular frame arranged to fit closely around the interior of the cover 3. To locate the cover engaging portion 21 within the cover 3, a plurality of holes 22 are provided within the cover engaging portion that correspond in location to a corresponding number of protrusions 23 formed on the underside of the upper surface of the cover 3. The protrusions 23 engage with the holes 22 of the cover engaging portion of the spring 5. Depending from the rearmost segment of the covering engaging portion 21 are two first spring portions 24 that are each formed as elongate strips. At the opposite end of the elongate first spring portions 24 they are joined by a horizontal cross member 25, from which depends a further pair of second spring portions 26. The second spring portions 26 are also elongate in formation and are also joined at their ends opposite from the first horizontal portion 25 by a further horizontal portion 27. Depending from the further horizontal portion 27 is a single further elongate member that, when in use, bears against the upper surface of the stack of cards 6 within the dispenser 1. At the areas where the cover engagement portion 21 and the first spring portions 24 are connected there is an inherent resiliency that causes the cover engaging portion and first spring portions to be urged away from one another. Similarly, the first spring portions 24 and second spring portions 26 are urged away from one another due to the resiliency of their connection at the first horizontal portion 25, and the second spring portions 26 and card bearing portion 28 are urged away from one another due to the inherent resiliency of the further horizontal portion 27.

The card dispenser allows the stack of cards 6 to be kept free of dust or other imperfections until the moment that a card is dispensed. There are no holes on the top surface of the cover and so contaminants cannot make contact with the surface of the cards while they are being stored. The horizontal ledge 19 also obliges a user to remove a card from the dispenser by grasping the card at its side edges, thus helping to avoid fingerprints or other marks from being transferred from the user's hands or fingers to the major surfaces of the card. In other preferred embodiments, the arrangement of the various elements of the device advantageously obliges the user to grasp the card only at its side edges.

The card dispenser 1 is also designed to be single use only. This allows the manufacturer to supply the dispensers with a stack of blank cards 6 sealed within the dispenser 1 and provides peace of mind to the user that the stack of cards has not been interfered with. Referring back to FIG. 4, each of the retaining limbs 11 of the retainers 4 has a weakened, wasted portion 29. As previously described, when assembled the edges of the frusto-conical portions 12 of the retaining limbs 11 are latched against the latch elements 14 provided in the base 2. If an attempt is made to remove the retainers 4 so as to dismantle the dispenser 1, the latching action between the frusto-conical portions 12 and the latch elements 14 provide an initial resistance to this. Should additional force be exerted on the retainers 4 the weakened wasted portions 29 of the retaining limbs 11 will fracture. Therefore, although the retainers 4 can be withdrawn from the base 2 and the cover 3 removed, the same retainer 4 cannot be secured back to the base 3 as the portion of the retaining limbs 11 having the frusto-conical elements 12 formed thereon have been broken away. Consequently, the retainer 4 is prone to simply fall out of the base 2, thus severely impairing the operation of the dispenser 1.

To prevent the dispenser 1 from rocking backwards as the cover 3 and the stack of cards 6 is drawn rearwards, a rear extending foot 30 is provided as illustrated in FIGS. 3 and 5. The base may also be fitted with rubber feet, or other high friction material, to prevent the base 2 from sliding backwards with the cover 3 if placed on a low friction surface.

1. Apparatus for dispensing a card or other substantially planar substrate therefrom, the apparatus comprising a base in engagement with a cover, the cover being arranged to house a plurality of cards therein, the cover and base being arranged to be movable with respect to one another such that on relative motion of the base and cover one of the plurality of cards is removable from the apparatus, wherein the cover includes an outwardly protruding ledge such that, when the apparatus is in a configuration allowing removal of a card, the ledge is configured and/or dimensioned to prohibit the grasping of the top surface of the card by a user.

2. Apparatus according to claim 1 wherein the ledge is narrower in width than the width of a card so as to allow the edges of the card to be grasped by the user.

3. Apparatus according to claim 1 or 2, wherein the cover is arranged to house the plurality of cards in a stack, with the lowermost card of the stack being removable from the apparatus on relative motion of the base and cover.

4. Apparatus according to claim 1, 2 or 3 wherein the relative motion of the cover with respect to the base imparts a relative motion of the plurality of cards with respect to the base with the exception of the card to be made accessible from the apparatus.

5. Apparatus according to any preceding claim, wherein the relative motion between the cover and base is a linear motion.

6. Apparatus according to any preceding claim wherein the relative motion between the base and cover is a reciprocating motion.

7. Apparatus according to any preceding claim wherein the cover is urged back towards an initial rest position by a suitable resilient member.

8. Apparatus according to claim 7 wherein the resilient member is a spring.

9. Apparatus according to any preceding claim wherein the motion of the cover is controlled by a motor.

10. Apparatus according to any preceding claim, wherein the base additionally has at least one wall portion that is arranged to be in engagement with a side surface of the lowermost card, wherein the wall portion maintains the lowermost card substantially stationary with respect to the base during the relative motion of the cover and base.

11. Apparatus according to claim 10 wherein the wall portion of the base is arranged to limit relative motion between the base and the lowermost card in one direction only.

12. Apparatus according to any preceding claim which includes card gripping means arranged to grip the lowermost card and impart relative motion between the card and the base.

13. Apparatus according to claim 12 wherein the card gripping means are friction pads mounted to the cover.

14. Apparatus according to any preceding claim, wherein the cover and base are fastened to one another by means of at least one retaining element, the retaining element being arranged to fracture on removal from the apparatus.

15. Apparatus according to claim 14 wherein the or each retaining element comprises an elongate side element and at least one retaining limb depending from the side element at substantially 90°.

16. Apparatus according to claim 14 or 15 wherein at least one slot is formed in the body of the cover and at least one aperture is formed in the base such that a retaining limb may be inserted through each at least one slot and aperture, such that the base and the cover are fastened together.

17. Apparatus according to claim 14, 15 or 16 wherein the at least one retaining limb is arranged to be latched in engagement with the base.

18. Apparatus according to any of claims 14-17 wherein the or each retaining element has at least one weakened area, the weakened area being arranged to fracture on application of a force in excess of a predetermined amount.

19. Apparatus according to any of claims 15-18 wherein the or each retaining limb comprises a guide element over which a portion of the cover can move.

20. Apparatus according to any preceding claim wherein the apparatus comprises a resilient member arranged to urge the plurality of cards towards the base.

21. Apparatus according to claim 20 wherein the resilient member is located between the cover and the plurality of cards and is arranged to exert a force against the cover and the plurality of cards.

22. Apparatus according to claim 20 or 21 wherein the resilient member comprises a cover engaging portion.

23. Apparatus according to claim 22 wherein the cover comprises protrusions formed on the inside of the cover and wherein apertures are formed in the cover engaging portion of the resilient member, the protrusions and apertures being positioned such that, when the apparatus is assembled, each protrusion engages with an aperture.

24. Apparatus according to claim 22 or 23 wherein the cover engaging portion of the resilient member is shaped so as to fit closely around the interior of the cover.

25. Apparatus according to any of claims 22-24 wherein the resilient member further comprises at least one spring portion.

26. Apparatus according to claim 25 wherein the at least one spring portion depends from the rearmost segment of the cover engaging portion.

27. Apparatus according to claim 25 or 26 wherein the at least one spring portion is formed as an elongate strip.

28. Apparatus substantially as herein described with reference to and as illustrated in the accompanying FIGS. 1-9.
